(19) United States
(12) Patent Application Publication
(10) Pub. No.: US 2010/0094691 A1
(43) Pub. Date: Apr. 15, 2010

(54) Stadium Portable Billboard Advertising

(76) Inventor: Cary D. Barfield, Laveen, AZ (US)

Correspondence Address: LOEN PATENT SERVICES, 2266 S Dobson Road, Mesa, AZ, 85202, US

(21) Appl. No.: 12/250,440

(22) Filed: Oct. 13, 2008

(51) Int. Cl. G06Q 30/00

(52) U.S. Cl. 705/14.5

(57) ABSTRACT

The present invention is directed at an advertising method whereby a portable billboard is carried by a vendor in a stadium who is selling products to the stadium audience.

### CROSS REFERENCE TO RELATED APPLICATIONS

Not Applicable.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

The present invention is directed to advertising in a stadium, public arena, or public gathering where an audience is available for the receipt of advertising. It is applicable to movable advertising billboards rather than a fixed location billboard. In particular, the present invention is directed toward portable advertising that is moved throughout a stadium by displays that are transported by vendors selling products such as food, beverages, memorabilia, promotional, or novelty items.

(2) Description of Related Art

Motorized mobile billboard advertising is known in the art and is used to advertise a variety of products. For example, U.S. Pat. No. 5,918,924 describes a mobile multi-message billboard advertising system which is placed on the sides of a truck. U.S. Pat. No. 649,622 describes a mobile advertising wagon with automatically changing advertising curtains. U.S. Pat. No. 4,495,719 describes a display board having a vertically disposed flat display surface mounted on a vehicle for supplying information to a large audience.

U.S. Pat. No. 6,898,517 describes a mobile billboard system that targets the advertising based on a global positioning system. U.S. Pat. No. 6,122,850 describes a lighted billboard system on a motor vehicle.

All of these advertising methods have at least some usefulness for promoting products in a public environment. However, they do not actively promote products by calling attention to the product by use of a vendor who is selling something else that the public wants. The advertising methods count on the motion of the vehicle to direct the attention of the public to the advertisement, which is not a strongly active means of calling attention to the ad, particularly in a crowded environment when there is an entertaining activity in progress.

There is a continual need in the advertising market to promote products in a highly competitive environment whereby a product receives frequent and repeated attention. A stadium environment in particular has a lot of advertising. Many stationary billboards are used to promote different products, services, and businesses. Some of the billboards have graphics that are illuminated and include video of various types. A stadium environment is not conducive to a motorized billboard system, such as already described by use of a motor vehicle, where a billboard or sign is readily moved through the seated audience.

The use of a person to independently carry a billboard around a stadium is an expensive method and likely to create a low advertising impact. The person carrying the billboard or sign is unlikely to obtain repeated or frequent attention of the audience.

### BRIEF SUMMARY OF THE INVENTION

The present invention is directed at an advertising method whereby a portable billboard is carried by a vendor in a stadium who is selling products to the stadium audience. As an option, the vendor will not have a display of his own product and will carry advertising that is separate from what is being to the stadium audience.

### BRIEF DESCRIPTION OF THE SEVERAL VIEWS OF THE DRAWING(S)

FIG. 1 shows a beer vendor's carrying cart that is rigged for advertising, but does not include information related to selling beer.

FIG. 2 shows a beer vendor's carrying cart that is rigged for advertising, and also advertising for selling beer.

FIG. 3 shows a hot dog vendor's carrying basket that includes a public service advertisement where a hat identifies the type of food being sold.

### DETAILED DESCRIPTION OF THE INVENTION

The present invention is directed at an advertising method whereby a portable billboard is carried by a vendor in a stadium who is selling products to the stadium audience. In one embodiment, the vendor will not have a display of his own product and will carry advertising that is separate from what is being sold to the stadium audience. It is especially intended for venues where vendors who sell items are allowed before, during, or after the event. It is useful for a vendor who is self propelled, that is, walks through the crowd or is mobile through very crowded and congested human traffic without the use of a motor.

The term stadium should be understood to mean a facility where there is a large grouping of an audience. It would include an outdoor or an indoor stadium such as used for football, baseball, basketball, hockey, and soccer. It would also be used for other sports or entertainment facilities such as theatre, music, and concerts. It would include facilities that are called arenas and amphitheaters.

The present invention is particularly useful for vendors who are selling items to the audience and includes food items, beverage items, memorabilia items (such as sports memorabilia), promotional items, novelty items, toys, gadgets, tools, music, video, or clothing which are commonly given to vendors to sell in a stadium setting. This list of items is meant to be examples of typical items stadium vendors commonly or historically sell to the audience; and should not be construed narrowly.

The present invention is not intended for concert halls and theaters where vendors who sell items and move throughout the audience before, during, or after the event are generally not permitted. For example, the present invention is not intended for use in a movie theater as popcorn is not sold by a vendor who calls out to the audience for sales during the movie.

The types of advertisement in the portable billboard includes, but is not limited to, scrolling, digital displays, and LED screens that are sufficiently lightweight. It also includes portable advertising such as paper, cardboard, plastic. The kinds of advertising used on the portable billboard would include public service announcements.

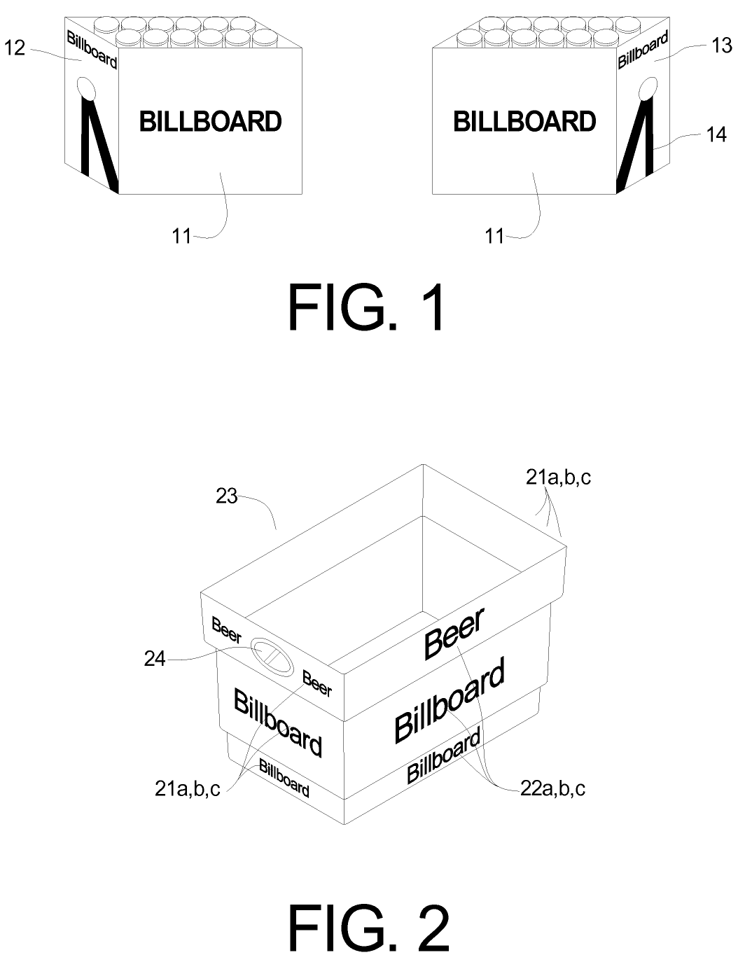

FIG. 1 shows an embodiment of the present invention where a beer vendor's carrying case is used to hold beer and also to provide advertisement space. Two side panels 12, 13 on the carrying case are available for advertising as well as a front panel 11. The rear most panel is out of view because it is being held against the vendor's body. Straps 14 are used by the vendor to hold the carrying case.

FIG. 2 shows an embodiment of the present invention where a beer vendor's carrying case is used to hold beer, provide advertisement space, and to provide notification for what is being sold by the vendor. In the carrying case that has several adjacent side panels 21a,b,c as shown, each panel carries the same or a separate billboard. Any one of the side panels 21a may notify the audience what is being sold by the vendor. A series of front panels 22a,b,c may replicate the side panels 21a,b,c or be arranged independently of the side panels in terms of how the portable billboard is displayed and product for sale is displayed. FIG. 2 shows only one possible method. A back side 23 of the carrying case is generally unavailable for advertising as it will be held against the vendor's body. However, it is optionally useful for advertising as the case will sometimes be set down during a sale. A side ring 24 is used for insertion of a strap to loop around the vendors arm, shoulder, body, or neck for convenient carrying. The side ring is usually on both sides of the carrying case due to the weight of the product being sold.

FIGS. 1 and 2 are not meant to be restrictive, but illustrative. The sides used for advertising could be very creative and each side may be unique as to the type and content of the ad. In one embodiment, multiple billboards are used and each billboard promotes the same or a different product.

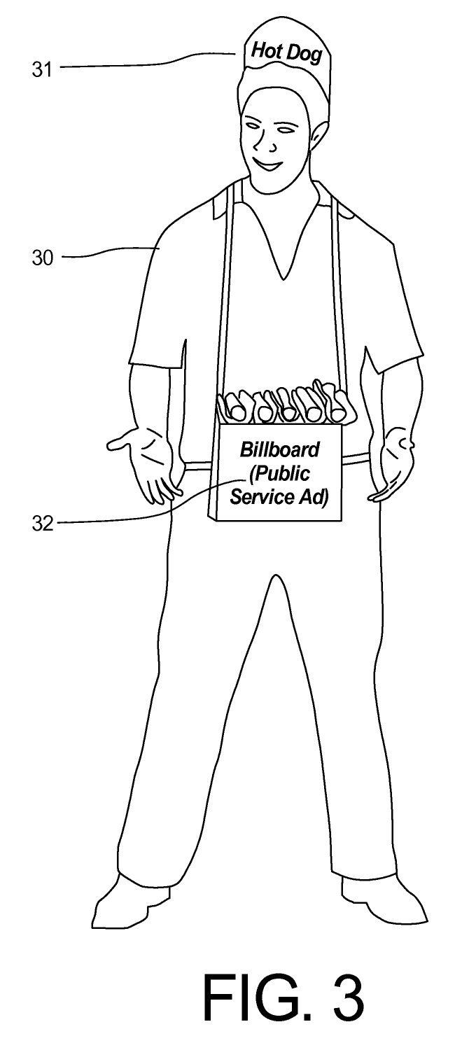

FIG. 3 shows another embodiment of the present invention where a hot dog vendor 30 is selling the food product and also providing a billboard or public service advertisement 32 on the carrying case which holds the hot dogs. In this case the advertisement is prominently displayed, and would easily be seen by the audience while the vendor engages in all aspects of selling the food item. As another embodiment of the present invention, the vendor also advertises the food product that is being sold by other simultaneous advertising means, such as a hat 31, so it is clear what is being sold to the audience which may not have a good line of sight to the vendor's carrying case.

The present invention is meant to provide a platform for all kinds of advertising. Public service or interest advertising, non-commercial advertising, cause or social marketing, are different terms for non-commercial, public interest issues and initiatives. Billboard advertising can be particularly useful for portable advertising and includes: targeted ads, one day campaigns, long term campaigns, notification of conventions and sporting events, store openings, and sales events. It can also be helpful in maintaining demand for well-known goods, introducing new products, and increasing demand for known products and services.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A method of providing advertising on a portable billboard in a stadium comprising
a. a vendor who is mobile within said stadium,
b. wherein said vendor is mobile by being self propelled,
c. wherein said vendor sells a product,
d. wherein said product is at least one item selected from the group consisting of:
i) a food item,
ii) a beverage item,
iii) a memorabilia item,
iv) a promotional item,
v) a novelty item,
vi) a toy item,
vii) a gadget item
viii) a tool item,
ix) music,
x) video, and
xi) a clothing item,
e. said portable billboard is carried around by said vendor, and
f. said portable billboard is substantially unrelated to said product.

2. The method according to claim 1 wherein said stadium is a sports stadium selected from the group consisting of: football, baseball, basketball, hockey, and soccer.

3. The method according to claim 1 wherein said portable billboard comprises at least one item selected from the group consisting of: i) scrolling, ii) digital displays, and iii) LED screen.

4. The method according to claim 1 wherein said portable billboard is substantially a public service announcement.

5. The method according to claim 1 wherein said portable billboard is substantially made out of paper, cardboard, or plastic.

6. The method according to claim 1 wherein said portable billboard is mounted on a carrying case which holds said product.
